(19) United States
(12) Patent Application Publication
(10) Pub. No.: US 2010/0103524 A1
(43) Pub. Date: Apr. 29, 2010

(54) METHOD FOR PRODUCING AN ANTI-REFLECTION SURFACE ON AN OPTICAL ELEMENT, AND OPTICAL ELEMENTS COMPRISING AN ANTI-REFLECTION SURFACE

(75) Inventors: Joachim Spatz, Heidenheim (DE); Robert Brunner, Jena (DE); Theobald Lohmueller, Nuernberg (DE)

Correspondence Address: FISH & RICHARDSON PC, P.O. BOX 1022, MINNEAPOLIS, MN, 55440-1022, US

(73) Assignees: CARL ZEISS AG, Oberkochen (DE); Max-Planck-Gesellschaft zur Forderung der Wissenschaftern e.V., Muenchen (DE)

(21) Appl. No.: 12/532,953

(22) PCT Filed: Mar. 22, 2008
(86) PCT No.: PCT/EP2008/002304

§ 371 Date: Sep. 24, 2009

(30) Foreign Application Priority Data
Mar. 27, 2007 (DE) 102007014538.3

(51) Int. Cl. G02B 1/11

(52) U.S. Cl. 359/585

(57) ABSTRACT

The invention relates to a method for producing an anti-reflection surface on an optical element, said method comprising the following steps: a) the optical element is prepared; b) uncharged, spherical, micellar polymer units comprising an inner core region and an outer shell region are prepared; and c) at least one region of the surface of the optical element is coated with polymer units in such a way that the polymer units are essentially regularly dispersed in a film-type layer over the surface of the optical element. The invention also relates to an optical element having an anti-reflection surface (28a, 28b, 28c) comprising spherical micellar polymer units (16a, 16b, 16c) having an inner core region (18) and an outer shell region (20) and being essentially regularly dispersed in a film-type layer (26a, 26b, 26c) over the surface of the optical element (22). The invention further relates to an optical element having an anti-reflection surface (34, 34a) comprising metal clusters (32, 32a) and/or metal oxide clusters (38, 38) which are essentially regularly distributed over the surface of the optical element (22).

The invention relates to a method for generating an antireflection surface on an optical element and to optical elements having an antireflection surface.

Gratings, lenses, in particular refractive lenses, diffractive structures, CGHs (computer-generated holograms) and refractive micro-optical elements in the form of spherical or aspherical microlenses may be mentioned as examples of optical elements.

In order to structure or modulate wavefronts of electromagnetic radiation, known optical elements are provided with a surface microstructure which utilises optical interference effects. Furthermore, optical elements may have a gradient in their optical density so that their optical properties change gradually. Overall, it is thus possible to modulate the wavefront after it has travelled through the optical element.

An important role in this regard is played by the treatment of optical boundary layers through the generation of an antireflection surface, by which the reflection of radiation striking the optical element is minimised. The antireflection effect depends on the angle of incidence of the incident radiation. It is desirable to ensure an antireflection effect even for large angles of incidence.

The reduction of reflection losses at optical interfaces is of great importance for many widely varying optical applications. At present, antireflection coatings based on multilayer systems are frequently used. Such multilayer systems generally comprise homogeneous layers with alternating higher and lower refractive indices, and utilise interference effects.

As an alternative to such multilayer systems, structured surfaces are employed whose structuring ranges around the order of magnitude of the wavelength of the light striking this structuring, or less. Such surface structures are also referred to as sub-lambda structures. By means of such sub-lambda structures, it is possible to achieve a graded transition between the refractive indices of the two media forming the interface.

It is known that a surface structure with essentially uniformly arranged elevations or depressions of the order of several nm, in particular from about 10 nm to about 650 nm, significantly increases the proportion of light with a wavelength between about 155 nm and about 10 μm which can be used by an optical element having such a surface structure, when it strikes the optical element at a particular angle, because the reflection of light is in turn greatly reduced. This antireflection effect occurs when the uniformly arranged elevations or depressions are of an order of magnitude which is less than the wavelength, in particular less than half the wavelength, of the radiation striking the surface structure. For visible light, the required periodicity of the surface structure ranges around an order of magnitude of less than about 300 nm, and for the UV radiation less than about 120 nm. Correspondingly, the surface structure should have a periodicity of less than about 600 nm when radiation in the near IR range is intended to be used.

Known methods for generating such an antireflection surface on an optical element are for example optical lithography, interference lithography or nano-imprinting methods. Immersion or spray coating methods based on sol-gel techniques have also already been used successfully.

However, the geometries achievable for the nanostructures which can be generated by these known methods are subject to comparatively narrow limitations. Furthermore, scattering effects which reduce the optical clarity of the optical element occur with some known antireflection surfaces.

An additional problem may arise when the antireflection surface being generated is formed by a layer which is not bonded stably enough to the optical element, and which becomes separated from the optical element owing to the stress occurring in the event of a curved surface being deformed. Such adhesion problems occur in particular when the materials used have different thermal expansion coefficients. Therefore, only a limited group of materials are suitable for forming an optical element made of a first material having an antireflection surface made of a second material. For this reason the optical parameters, which the optical element provided with the antireflection surface can satisfy, are in turn restricted.

In most cases, these difficulties that occur in practice no longer justify the equipment and financial outlay which must be expended in order to generate an antireflection surface by the known methods mentioned above.

It is therefore an object of the invention to provide a method for generating an antireflection surface on an optical element, by which the said difficulties are reduced.

This object is achieved according to the invention by a method according to claim 1, which comprises the following steps:
a) providing the optical element;
b) providing unladen spherical micelle-like polymer units, which have an inner core region and an outer shell region;
c) coating at least one region of the surface of the optical element with polymer units, so that the polymer units are distributed in a film-like layer with an essentially regular arrangement on the surface of the optical element.

The term unladen spherical micelle-like polymer units is generally intended to mean micelles, vesicles or complex aggregates which are formed in aqueous or organic solution from macromolecular amphiphilics in a spherical structure. In particular, two separate spherical micelle-like polymer units of the same type have an essentially equal spatial extent.

Unladen spherical micelle-like polymer units, which can be used in the method according to the invention, order themselves on a surface by a self-organisation process in a layer with an essentially regular arrangement, as is known for example from DE 2004 043 305 A1.

It has been found that a layer of spherical micelle-like polymer units acts particularly well as an antireflection surface for light with a wavelength of between about 155 nm and about 10 μm, when the spherical micelle-like polymer units have a diameter of between about 10 nm and about 650 nm.

Possible ways in which micelle-like polymer units can be applied onto a surface of a structure are known, for example, from EP 1 027 157 B1.

The spherical micelle-like polymer units distributed with an essentially regular arrangement on the surface of the optical element form an antireflection surface on the coated optical element. The wavefronts striking this antireflection surface are modified in the desired sense by the interaction with the micelle-like polymer units.

Advantageous refinements of the method according to the invention are specified in the dependent claims.

The unladen spherical micelle-like polymer units can be generated straightforwardly in step b) when one or more polymers are taken up in a solvent, particularly in toluene.

Block copolymers have proven advantageous for forming an efficient antireflection surface. Preferably, one or a mixture of several of the following block copolymers is used as the block copolymer: polystyrene-b-polyethylene oxide, polystyrene-b-poly(2-vinylpyridine), polystyrene-b-poly(4-vinylpyridine). Polystyrene-b-poly(2-vinylpyridine) is preferably used.

An alternative antireflection surface can be generated when the method furthermore comprises the step of loading at least some of the polymer units with a metal compound or with a metal cluster or with a metal oxide cluster. The procedure for loading the polymer units with the said compounds is known from EP 1 027 157 B1, cited above. There, these metallic particles are merely used as an etching mask for a subsequent plasma treatment of the surface, the polymer units and the metallic particles being removed by or after the plasma treatment. In contrast to this, it has been found that a layer of micelle-like polymer units loaded in this way forms an efficient antireflection surface on an optical element.

In particular, it has proven advantageous for one or a mixture of several of the following metal compounds to be used as the metal compound: HAuCl₄, MeAuCl₄ with Me=alkali metal, H₂PtCl₆, Pd(Ac)₂, Ag(Ac), AgNO₃, InCl₃, FeCl₃, Ti(OR)₄, TiCl₄, TiCl₃, CoCl₃, NiCl₂, SiCl₄, GeCl₄, GaH₃, ZnEt₂, Al(OR)₃, Zr(OR)₄ and/or Si(OR)₄ with R=unbranched or branched C₁-C₈ alkyl radical, ferrocene, Zeise's salt, SnBu₃H.

In a first variant, the loading of at least some of the polymer units with a metal compound or with a metal cluster or with a metal oxide cluster is carried out as step b1) after carrying out step b) and before carrying out step c). In a second variant, the loading of at least some of the polymer units may be carried out as step c1) only after carrying out step c).

The loading in step b1) or in step c1) is straightforwardly carried out in solution, particularly in toluene. For example, a selected metal compound may simply be added to the solution in which the micelle-like polymer units have been generated.

As an alternative, at least some of the polymer units may be loaded with a metal cluster in step b1) or in step c1) by an electrochemical process.

A metal cluster carried by the micelle-like polymer units can also be achieved when the method comprises, as step d), the conversion of at least some of the metal compound of a loaded polymer unit into a metal cluster and/or a metal oxide cluster.

This may advantageously be done by means of a chemical reaction, in particular a reduction reaction with hydrazine, when a metal compound of a loaded polymer unit is intended to be converted into a metal cluster. If on the other hand conversion of the metal compound of a loaded polymer unit into a metal oxide cluster is desired, then this may advantageously be done by means of exposure to energetic radiation, in particular UV radiation.

It has been found that an efficient antireflection surface can also be formed by metal clusters and/or metal oxide clusters which lie freely on the surface of the optical element without a polymeric or other shell. Such an antireflection surface can advantageously be generated when the method furthermore comprises, as step e), removal of the polymer units from the surface of the optical element, essentially regularly arranged metal clusters and/or metal oxide clusters being left behind on the surface of the optical element. Expressed in other words, metal clusters or metal oxide clusters are left behind instead of the micelle-like polymer units, and their respective position on the optical element corresponds without any great change to the position which was previously occupied by the associated polymer unit that has been removed.

The removal of the polymer units in step e) may advantageously be carried out by etching, reduction or oxidation. Preferably, the polymer units are removed in step e) by plasma etching, for which in particular an argon, oxygen or hydrogen plasma is used.

This antireflection surface thus constructed from metal clusters and/or metal oxide clusters may also be subsequently modified further, to which end the method advantageously furthermore comprises as step f) the metal clusters and/or metal oxide clusters being enlarged by depositing a metal and/or a metal compound onto the metal clusters or the metal oxide clusters.

In this way, the antireflection surface is modified so that although the distances between the centres of the metal clusters or metal oxide clusters remain unchanged, the distances between the outer contours of the clusters in question are however reduced.

Advantageously, the deposition of the metal and/or metal oxide in step f) is carried out electrolessly.

The method, known from EP 1 027 157 B1, for generating a microstructure on a surface can be used advantageously when the method according to the invention furthermore comprises as step g) a microstructure, which acts as an antireflection surface, being etched into the surface of the optical element, the metal clusters and/or metal oxide clusters distributed on the surface of the optical element acting as an etching mask. It is particularly advantageous for the etching of the microstructure into the surface of the optical element in step g) to be carried out by plasma etching, for which in particular a CF₄/argon plasma is used.

It is also an object of the invention to provide an optical element having an antireflection surface, with which the difficulties mentioned in the introduction, for example separation of the antireflection surface from the optical element, are reduced.

This object is achieved for an optical element having an antireflection surface in that the antireflection surface comprises spherical micelle-like polymer units which have an inner core region and an outer shell region and are distributed in a film-like layer with an essentially regular arrangement on the surface of the optical element.

As already mentioned above, such micelle-like polymer units organise themselves and thus form a microstructure which acts as an antireflection surface.

As regards clusters carried by the micelle-like polymer units, it has been found that it is advantageous in particular for the metal clusters to comprise one or more clusters of gold, platinum or palladium.

If a metal oxide cluster is carried by the micelle-like polymer units, then for the antireflection surface it has proven advantageous for it to comprise one or more clusters of titanium dioxide, iron oxide or cobalt oxide.

An efficient antireflection surface can also be formed when at least some of the polymer units are loaded with a cluster of mixed metallic systems. In this case, it is advantageous for the cluster of mixed metallic systems to comprise one or more of the following mixed metallic systems: Au/Fe₂O₃, Au/CoO, Au/Co₃O₄, Au/ZnO, Au/TiO₂, Au/ZrO₂, Au/Al₂O₃, Au/In₂O₃, Pd/Al₂O₃, Pd/ZrO₂, Pt/graphite and/or Pt/Al₂O₃.

The object of providing an optical element having an antireflection surface, which compensates for the difficulties mentioned above, is furthermore achieved for an optical element having an antireflection surface in that the antireflection surface comprises metal clusters and/or metal oxide clusters, which are distributed in an essentially regular arrangement on the surface of the optical element. In this context, the metal clusters and/or metal oxide clusters lie freely and without a polymeric or other shell on the surface of the optical element.

Exemplary embodiments of the invention will be explained in more detail below with the aid of the drawing, in which:

FIG. 1 schematically shows a block copolymer;

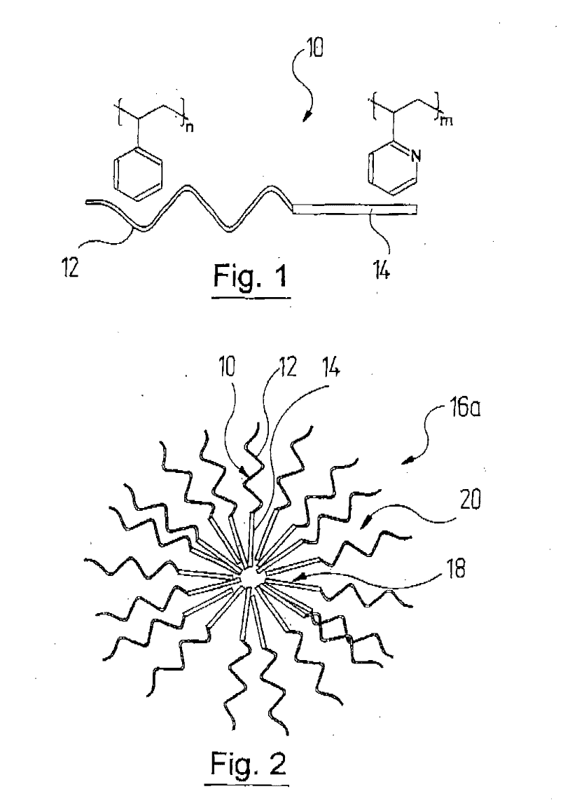

FIG. 2 schematically shows an unladen micelle, constructed from the block copolymer of FIG. 1, having an inner core region and an outer shell region;

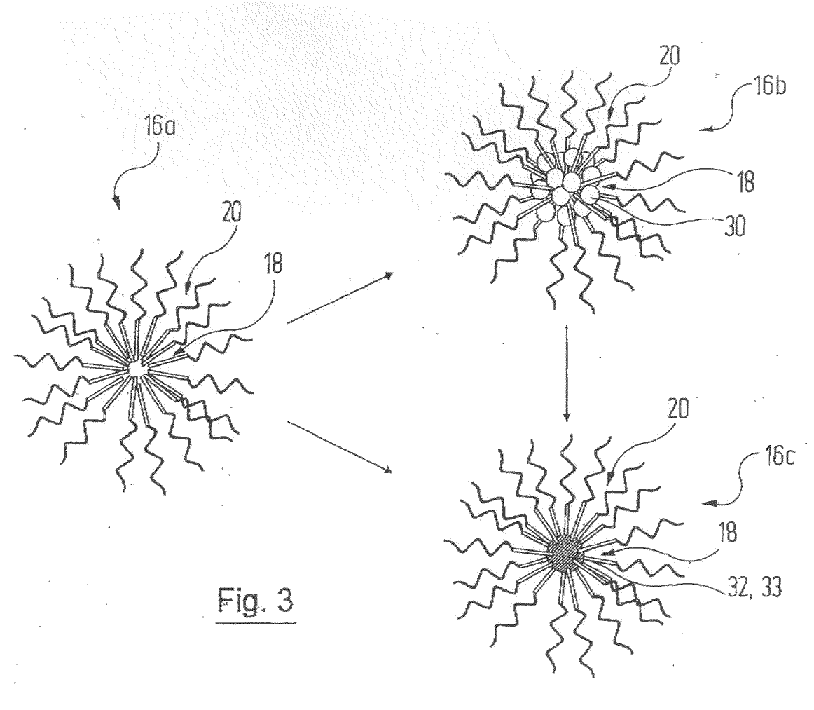

FIG. 3 schematically shows the loading of the core region of the block-copolymer micelle of FIG. 2 with a metal compound on the one hand or a metal or metal oxide cluster on the other hand, and schematically shows the conversion of the metal compound in the core of the block-copolymer micelle into a metal or metal oxide cluster;

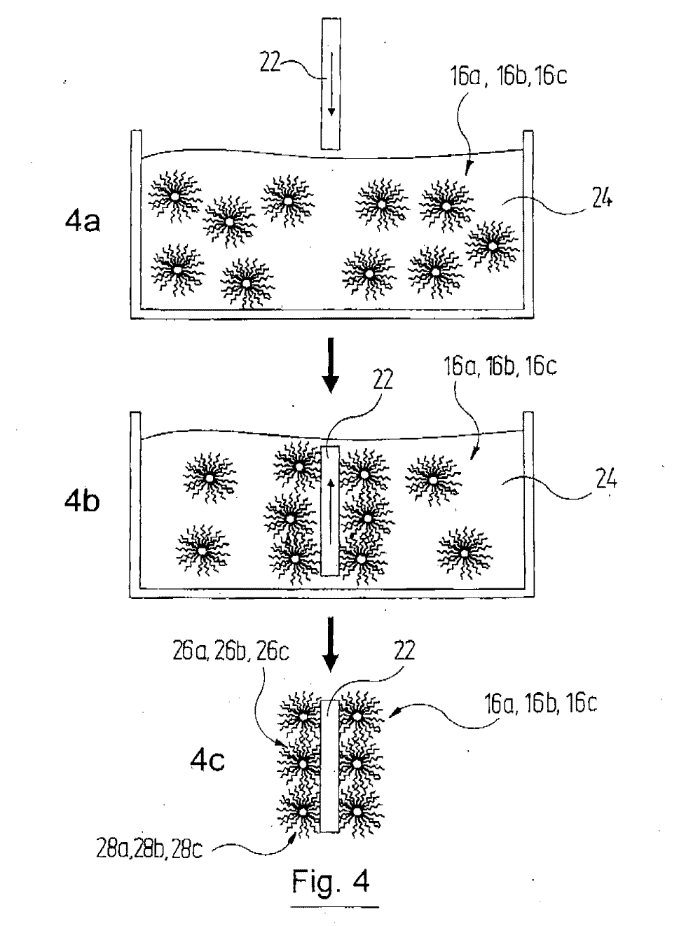

FIG. 4 schematically shows the coating of an optical element with unladen or loaded block copolymer micelles of FIG. 3;

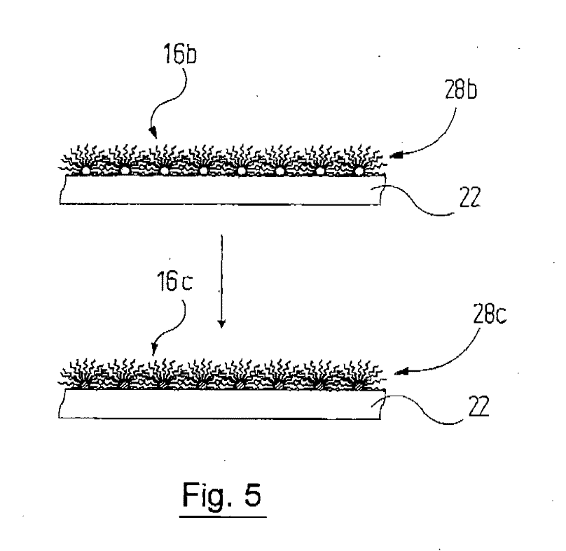

FIG. 5 schematically shows the conversion of the metal compound in the core region of the block-copolymer micelle of FIG. 3 into a metal or metal oxide cluster, after the optical element has already been coated according to FIG. 4 with block-copolymer micelles loaded with a metal compound;

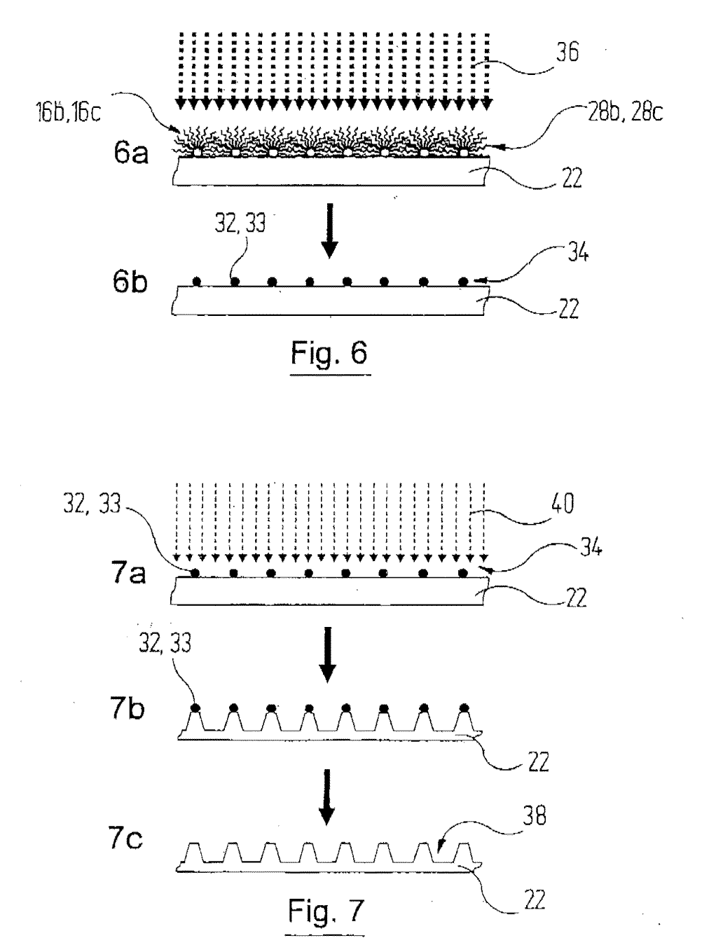

FIG. 6 schematically shows the removal of the block-copolymer micelles from the surface of the optical element, nanoclusters being left behind on the surface of the optical element;

FIG. 7 schematically shows the etching of a microstructure, acting as an antireflection surface, into the surface of the optical element;

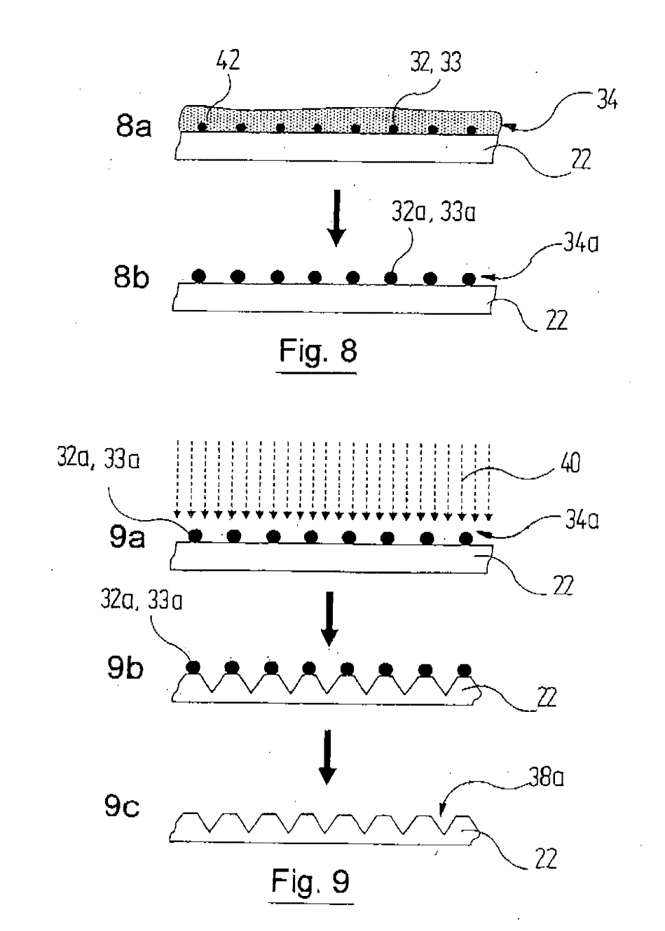

FIG. 8 schematically shows the enlargement of the nanoclusters left behind after removing the block-copolymer micelles;

FIG. 9 schematically shows the etching of an alternative microstructure, acting as an antireflection surface, by using the enlarged nanoclusters as an etching mask;

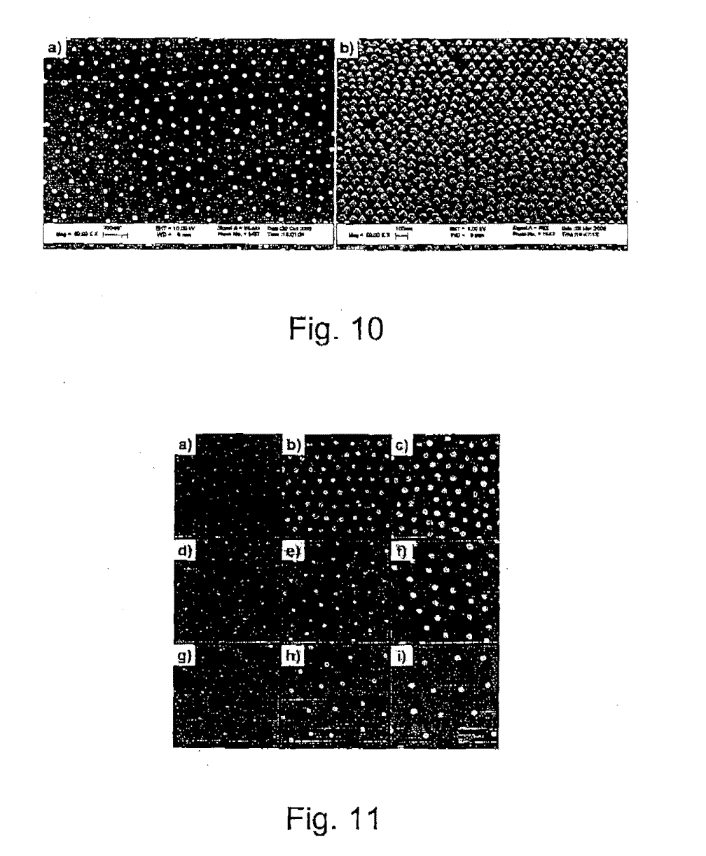

FIG. 10 shows scanning electron microscope images of a glass surface covered with metal clusters, before and after etching with a CF₄/argon plasma; and

FIG. 11 shows scanning electron microscope images of surfaces covered with metal clusters, in which the metal clusters have different spatial extents and lateral spacings.

FIG. 1 schematically shows a polymer from which spherical micelle-like polymer units can be formed, with reference to the example of a block copolymer denoted overall by 10. It has a nonpolar block 12 and a polar block 14.

Other polymers suitable for the method explained below are for example graft copolymers, star polymers, dendritic polymers, star-block polymers or block-star polymers.

As the block copolymer 10, polystyrene-b-poly(2-vinylpyridine), which is shown in FIG. 1, is envisaged in particular. In this, polystyrene forms the nonpolar block 12 and poly(2-vinylpyridine) forms the polar block 14. Other highly suitable block copolymers are polystyrene-b-polyethylene oxide and polystyrene-b-poly(4-vinylpyridine). A mixture of the said block copolymers may also be used.

Furthermore a polymer other than polystyrene may form the nonpolar block 12, for example polyisoprene, polybutadiene, polymethyl methacrylate or other polymethacrylates. Besides the polymers polyethylene oxide, poly(2-vinylpyridine) and poly(4-vinylpyridine) mentioned above, the polar block 14 may be formed by another polymer. For this, for example polyacrylic acid, polymethacrylic acid, amino-substituted polystyrenes, polyacrylates or polymethacrylates, amino-substituted polydienes, polyethylene imines, saponified polyoxazolines or hydrated polyacrylonitrile may be envisaged.

The method according to the invention will be explained below with reference to the example of the aforementioned two-block copolymer polystyrene-b-poly(2-vinylpyridine) 10, polystyrene being abbreviated to PS and poly(2-vinylpyridine) being abbreviated to P2VP.

In order to generate unladen micelles in step b) which was mentioned in the introduction, the two-block copolymer PS-b-P2VP 10 is dissolved in an amount of from about 10⁻3 to about 100 mg/ml, preferably about 5 mg/ml, in a nonpolar solvent such as for example toluene. Over a period of several hours, unladen micelle-like polymer units are formed from the two-block copolymer PS-b-P2VP 10 in the form of micelles 16a, one of which is shown in FIG. 2. In these unladen micelles 16a, the polar P2VP blocks 14 are oriented inwards and form an inner core region 18, whereas the nonpolar PS blocks 12 are oriented outwards and form an outer shell region 20. Such an unladen micelle 16a is also shown in FIG. 3.

In the aforementioned step c) which follows step b), an optical element 22 is coated at least partially with these micelles 16a, which is illustrated by way of example in FIG. 4. The optical element 22 represented highly schematically there may be an optical element having an at least locally curved surface, for example a lens or a corresponding grating, or alternatively an optical element with a planar surface, for example a flat glass, either of which is intended to be provided with an antireflection surface.

As may be seen in FIG. 4, an immersion method is preferably used for coating at least one region of the surface of the optical element 22 in step c) with the micelles 16a. To this end the optical element 22 to be coated is immersed into a solution 24 comprising the micelles 16a, which is shown in FIG. 4 at 4a. The solution 24 may for example be the aforementioned solution of unladen micelles 16a in toluene generated in step b).

At 4b (FIG. 4), the optical element 22 is pulled from the solution 24 with a maximally constant pulling speed of between 0.001 mm/min and 2 m/min. A film-like layer 26a of the micelles 16a is then formed on that surface region of the optical element 22 which was immersed into the solution, as may be seen at 4c in FIG. 4.

In particular, a pulling speed of from 1 mm/min to 40 mm/min, preferably from 1 mm/min to 10 mm/min, particularly preferably 5 mm/min, leads to the desired result.

Instead of the immersion method already explained, a spin coating method may for example also be carried out in step c), as is known per se.

Owing to the self-organisation of the micelles 16a as mentioned in the introduction, they are distributed in the film-like layer 26a with an essentially regular arrangement on the surface of the optical element 22.

The film-like layer 26a of unladen micelles 16a forms an antireflection surface 28a of the optical element 22. The micelles 16a respectively have a diameter of from about 10 nm to about 650 nm depending on the block copolymer 10 on which they are based, and they therefore form a nanostructure with maximum dimensions which are less than the wavelengths of the radiation being used.

The nanostructure of the antireflection surface 28 can be adjusted through an appropriate selection of the polymers on which the micelles 16a are based, and which were mentioned above in connection with FIG. 1. An appropriate selection of the chain lengths of the nonpolar block 12 and/or the polar block 14 also has an influence on the size of the micelles 16a formed therefrom, and therefore on the resulting topography of the antireflection surface 28.

The effect of the antireflection surface 28a formed by the micelles 16a is that a smaller proportion of light is reflected and can no longer be used. The angle of incidence at which the light rays can strike the optical element 22, and at which these light rays still pass through the optical element 22, is therefore also increased significantly.

In an alternative embodiment of the method, an alternative antireflection surface 28b is generated on the surface of the optical element 22 instead of an antireflection surface 28a formed by unladen micelles 16a. It is formed by a film-like layer 26b of micelles 16b which are loaded with a metal compound 30. A micelle 16b loaded in this way is shown schematically in FIG. 3, particles of the metal compound 30 being indicated as white spheres which are arranged in the core region 18 of the micelles 16b.

Suitable metal compounds 30 are for example compounds of Au, Pt, Pd, Ag, In, Fe, Zr, Al, Co, Ni, Ga, Sn, Zn, Ti, Si and Ge. In particular, the following metal compounds may be used: HAuCl₄, MeAuCl₄ with Me=alkali metal, H₂PtCl₆, Pd(Ac)₂, Ag(Ac), AgNO₃, InCl₃, FeCl₃, Ti(OR)₄, TiCl₄, TiCl₃, CoCl₃, NiCl₂, SiCl₄, GeCl₄, GaH₃, ZnEt₂, Al(OR)₃, Zr(OR)₄ and/or Si(OR)₄ with R=unbranched or branched C₁-C₈ alkyl radical, ferrocene, Zeise's salt, SnBu₃H or a mixture of several of these. HAuCl₄ is preferably used as the metal compound 30.

The loading of the unladen micelles 16a with the metal compound 30 is carried out in a first variant of the method as step b1) after carrying out step b) and before carrying out step c).

Micelles 16b loaded with a metal compound 30 are then formed for example by adding the metal compound 30 to the unladen micelles 16a in the solution 24 and stirring strongly for an extended period of, for example, about 24 hours.

Only then is the optical element 22 coated with a film-like layer 26b of micelles 16b by introducing the optical element 22 into the solution 24 comprising the loaded micelles 16b and pulling it out therefrom with a slow defined movement, as was explained above with reference to step c) and is shown in FIGS. 4 at 4a and 4b.

A section of the optical element 22 formed in this way having an antireflection surface 28b, which is formed by loaded micelles 16b, is shown in FIG. 5, the antireflection surface 28b being represented only on one side of the optical element 22.

In a second variant of the method, the loading of the micelles 16a with a metal compound 30 is carried out as step c1) after carrying out step c). This means that the optical element 22 is initially coated in the manner described in connection with FIG. 4 with a film-like layer 26a of unladen micelles 16a. The optical element 22 carrying the unladen micelles 16a is then introduced into a solution comprising the metal compound 30, which is not shown separately here.

This second variant of the method likewise leads to an optical element having an antireflection surface 28b, which is formed by micelles 16b loaded with a metal compound 30 and is shown in FIG. 5.

In an alternative embodiment of the method, the unladen micelles 16a may also be loaded electrochemically with a cluster in the form of a metal cluster 32 either in step b1) or in step c1). Such a micelle 16c is shown in FIG. 3, the metal cluster 32 being indicated in the form of a larger shaded sphere.

In order to obtain micelles 16c loaded with a metal cluster 32, it is furthermore possible to convert the particles of the metal compound 30 which are carried by the micelles 16b into a metal and thus into a metal cluster 32. This may, for example, be done by a reduction reaction with hydrazine in solution.

Another possibility consists in exposing the micelles 16b to energetic radiation, in particular UV light or X-radiation, so that clusters are obtained in the form of metal oxide clusters 33 in the core region 18 of the micelles 16c, which are likewise indicated in FIG. 3 by the shaded larger sphere.

This conversion of the metal compound 30 of a micelle 16b into a metal cluster 32 or a metal oxide cluster 33 is carried out as step d) of the method, and may optionally be carried out on the one hand before coating the optical element 23 with corresponding micelles 16 or on the other hand after such coating.

In the first case, the solution 24 thus initially contains micelles 16b loaded with a compound 30 containing metal, which are converted as described above into micelles 16c having metal clusters 32 or metal oxide clusters 33. The micelles 16c are then applied as described above onto the surface of the optical element (cf. FIG. 4), which leads to the optical element 22 shown in FIG. 5 that comprises an antireflection surface 28c which is constructed from micelles 16c.

FIG. 5 furthermore illustrates the aforementioned second case, i.e. when an optical element 22 having an antireflection surface 28b is initially formed and the micelles 16b forming it, which are loaded with one or more metal compounds 30, are converted by one of the measures described above into micelles 16c having metal clusters 32 or metal oxide clusters 33.

The metal clusters 32 thus formed in the core region 18 of the micelles 16c are in particular oxygen-resistant noble metals, such as Au, Pt and/or Pd or other metals, for example Fe, Co or Ni, depending on the metal compound or compounds 30 used in step b1) or c1).

If metal oxide clusters 32 are formed in the core region 18 of the micelles 16c, these will preferably be TiO₂ or Fe₂O₃.

If the unladen micelles 16a are loaded with a mixture of appropriate metal compounds in step b1) or step c1), then these may also be converted in step d) into clusters of mixed metallic systems, for example Au/Fe₂O₃, Au/CoO, Au/Co₃O₄, Au/ZnO, Au/TiO₂, Au/ZrO₂, Au/Al₂O₃, Au/In₂O₃, Pd/Al₂O₃, Pd/ZrO₂, Pt/graphite and/or Pt/Al₂O₃.

In summary, three alternative embodiments of antireflection surfaces 28a, 28b, 28c can respectively be generated in various ways on the optical element 22, by appropriately carrying out the method steps already explained above. The antireflection surface 28a is formed by unladen micelles 16a, whereas the antireflection surface 28b is constructed from micelles 16b which are loaded with a metal compound 30 or a mixture of several metal compounds 30. The third possible antireflection surface 28c comprises micelles 16c which in their turn carry metal clusters 32 or metal oxide clusters 33.

The term cluster is to be interpreted as a generic term for an accumulation of compounds or pure metals, which may be held together on the one hand by covalent bonds or on the other hand by other forces.

A further alternative antireflection surface 34 may now be generated by removing the block copolymers 10 of the micelles 16b or 16c of the antireflection surface 28b or 28c, essentially uniformly arranged metal clusters 32 and/or metal oxide clusters 33 being left behind on the surface of the optical element 22. These metal clusters 32 or metal oxide clusters 33, which are arranged freely on the surface of the optical element 22 and no longer have a polymeric or other shell, are represented in FIGS. 6 to 9 as nanoclusters 32, 33 filled in black.

The block copolymers 10 of the micelles 16b or 16c are removed in the step e) mentioned in the introduction, for example by means of an etching, reduction or oxidation method. In particular a gas plasma 36 is used in this step e), preferably an argon, oxygen or hydrogen plasma.

If the antireflection surface being treated is the antireflection surface 28b, in which the micelles 16b carry particles of the metal compound 30 as metal precursors, conversion of the metal compound 30 into a crystalline metallic or oxidic modification in the form of the metal clusters 32 or metal oxide clusters 33 will be carried out by the plasma treatment.

These nanoclusters 32 or 33 lie on the surface of the optical element 22 essentially with the same regular arrangement as was previously occupied by the micelles 16b or 16c. The respective distance between two nanoclusters 32 or 33 consequently depends on the diameter of the micelles 16b or 16c used, which as already mentioned may lie between about 10 nm and about 650 nm.

On the basis of the nanoclusters 32 or 33, which already form the antireflection surface 34, a further alternative antireflection surface 38 may be formed, which is illustrated in FIG. 7. To this end a microstructure acting as an antireflection surface 38 is etched into the optical element 22 by a CF₄/argon plasma 40, nanoclusters 32 or 33 of the antireflection surface 34 acting as an etching mask (cf. FIG. 7 at 7a).

After this process, the nanoclusters 32 or 33 are removed in a manner known per se from the surface of the optical element 22 (cf. FIG. 7 at 7b), so that the structured antireflection surface 38 remains (cf. FIG. 7 at 7c).

In a further alternative, the antireflection surface 34 constructed from the nanoclusters 32 or 33 may be modified further (cf. FIG. 8) through enlargement of the nanoclusters 32, 33 in step f), which was mentioned in the introduction, by depositing an appropriate metal compound/an appropriate metal onto the nanoclusters 32 or 33 to form nanoclusters 32a or 33a. These then form an antireflection surface 34a.

The enlargement of the nanoclusters 32 or 33 may for example be carried out through electroless deposition, by introducing the optical element 22 having the antireflection surface 34 into a solution 42 to which an appropriate metal compound is added, which is indicated in FIG. 8 at 8a. Another variant, not separately represented here, is to enlarge the nanoclusters 32 or 33 forming the antireflection surface 34 by means of an electrochemical method to form the nanoclusters 32a or 33a. The latter are shown in FIG. 8 at 8b.

These nanoclusters 32a or 33b, which are larger than the nanoclusters 32 or 33, may then likewise be used as an etching mask for a plasma 40, which is shown in FIG. 9. As may be seen there at 9c in comparison with FIG. 7 at 7c, the etching mask formed by the larger nanoclusters 32a or 33a leads to a modified microstructure and therefore to a modified antireflection surface 38a on the optical element 22. By varying the size of the nanoclusters 32 or 33 in step f), a particular etching mask can therefore be produced in a controlled way.

The larger nanoclusters 32a or 33a arranged in a structured way on the surface of the optical element 22 also already form an antireflection surface 34a, so that the optical element 22 can be used with this antireflection surface 34.

The shape of the individual structures forming the antireflection surface, and the extent to which these individual structures rise above the surface of the optical element 22, are crucial characteristics for the optical effect of the antireflection surface 38 or 38a (cf. FIGS. 7 and 9). The shape of these individual structures, which may for example correspond to a cylinder, a sphere or a pyramid, or which may be such that a plurality of individual structures can form a so-called “cobblestone profile”, can be adjusted through an appropriate selection of the polymers, the loading materials and the etching process.

FIG. 10a) shows a scanning electron microscope image of a glass surface, on which nanoclusters which appear as white circles have been applied by the method explained above. Here, [PS(1827)-b-P2VP(523)] micelles loaded with HAuCl₄ have been used as block-copolymer micelles. The gold cluster diameter is about 36 nm, and the lateral spacing between two gold clusters is about 150 nm.

FIG. 10b) shows the corresponding glass surface after etching with a CF₄/argon plasma. A pyramidal etching profile in the surface of the glass plate can be seen. Image 10a) is taken in plan view at an angle of about 90° to the surface, and image 10b) is taken at an angle of about 45° to the surface.

FIG. 11 shows scanning electron microscope images of various cluster structures, from which the possibilities of variation for generating different antireflection surfaces may be seen.

The lateral cluster spacings on the images 11a), 11b) and 11c) lie in the range of 115±22 nm, in the range of 163±34 nm on the images 11d), 11e) and 11f), and in the range of 232±54 nm on the images 11g), 11h) and 11i). These different lateral spacings were achieved by using different polymers, or polymers with different chain lengths, for applying the nanoclusters. According to step f) of the method, the nanoclusters were enlarged starting from the structures according to images 11a), 11d) and 11g) from about 10 nm to about 25 nm (11b), 11e) and 11h)) or to about 50 nm (11c), 11f) and 11i)).

As revealed by the description above, these nanostructures may either act directly per se as an antireflection surface of the corresponding optical element or be used as an etching mask for a further plasma treatment, so that a corresponding surface microstructure is etched into the relevant optical element.

1. A method, comprising:
a) providing an optical element having a surface;
b) providing unladen spherical micelle-like polymer units, which have an inner core region and an outer shell region; and
c) coating at least one region of the surface of the optical element with the polymer units, so that the polymer units are distributed in a film-like layer with an essentially regular arrangement on the surface of the optical element, thereby providing an antireflection surface structure on the surface of the optical element.

2. The method according to claim 1, wherein providing the unladen spherical micelle-like spherical micelle-like polymer units comprises one or more polymers being dissolved in a solvent.

3. The method according to claim 2, wherein a block copolymer is used as the polymer.

4. The method according to claim 3, wherein the block copolymer comprises at least one block copolymer selected from the group consisting of polystyrene-b-polyethylene oxide, polystyrene-b-poly(2-vinylpyridine), and polystyrene-b-poly(4-vinylpyridine).

5. The method according to claim 1, further comprising loading at least some of the polymer units with a metal compound or with a metal cluster or with a metal oxide cluster.

6. The method according to claim 5, wherein the metal compound comprises at least one compound selected from the group consisting of HAuCl₄, MeAuCl₄ with Me=alkali metal, H₂PtCl₆, Pd(Ac)₂, Ag(Ac), AgNO₃, InCl₃, FeCl₃, Ti(OR)₄, TiCl₄, TiCl₃, CoCl₃, NiCl₂, SiCl₄, GeCl₄, GaH₃, ZnEt₂, Al(OR)₃, Zr(OR)₄ and Si(OR)₄,
wherein R is selected from the group consisting of an unbranched C₁-C₈ alkyl radical, a branched C₁-C₈ alkyl radical, ferrocene, Zeise's salt, and SnBu₃H.

7. The method according to claim 5, wherein loading of at least some of the polymer units with a metal compound or with a metal cluster or with a metal oxide cluster is carried out after carrying out b) and before carrying out c).

8. The method according to claim 5, wherein loading of at least some of the polymer units with a metal compound or with a metal cluster or with a metal oxide cluster is carried out after carrying out c).

9. The method according to claim 7, wherein loading of at least some of the polymer units is carried out in solution.

10. The method according to claim 7, wherein at least some of the polymer units are loaded with a metal cluster by an electrochemical process.

11. The method according to claim 5, further comprising:
converting at least some of the metal compound of a loaded polymer unit into a metal cluster and/or a metal oxide cluster.

12. The method according to claim 11, wherein the conversion of at least some of the metal compound of a loaded polymer unit into a metal cluster is carried out by of a chemical reaction.

13. The method according to claim 11, wherein conversion of at least some of the metal compound of a loaded polymer unit into a metal oxide cluster in d) is carried out by exposure to energetic radiation.

14. The method according to claim 5, further comprising:
removing the polymer units from the surface of the optical element, thereby leaving behind essentially regularly arranged metal clusters and/or metal oxide clusters on the surface of the optical element.

15. The method according to claim 14, wherein the unladen spherical micelle-like polymer units are removed in e) by etching, reduction or oxidation.

16. The method according to claim 15, wherein the polymer units are removed in e) by plasma etching.

17. The method according to claim 14, further comprising:
enlarging the metal clusters and/or metal oxide clusters by depositing a metal and/or a metal compound onto the metal clusters or the metal oxide clusters.

18. The method according to claim 17, wherein the deposition of the metal and/or metal oxide in f) is carried out electrolessly.

19. The method according to claim 14, further comprising:
etching a microstructure, which acts as an antireflection surface, into the surface of the optical element, the metal clusters and/or metal oxide clusters being distributed on the surface of the optical element acting as an etching mask.

20. The method according to claim 19, wherein etching of the microstructure into the surface of the optical element in g) is carried out by plasma etching.

21. An article, comprising:
an optical element having a surface; and
an antireflection surface structure,
wherein the antireflection surface structure comprises spherical micelle-like polymer units which have an inner core region and an outer shell region and are distributed in a film-like layer with an essentially regular arrangement on the surface of the optical element.

22. The article according to claim 21, wherein the polymer units comprise at least one block copolymer.

23. The article according to claim 22, wherein the block copolymer comprises at least one polymer selected from the group consisting of polystyrene-b-polyethylene oxide, polystyrene-b-poly(2-vinylpyridine), and polystyrene-b-poly(4-vinylpyridine).

24. The article according to claim 21, wherein at least some of the polymer units are loaded with a metal compound and/or a metal cluster and/or a metal oxide cluster.

25. The article according to claim 24, wherein the metal compound comprises at least one compound selected from the group consisting of HAuCl₄, MeAuCl₄, H₂PtCl₆, Pd(Ac)₂, Ag(Ac), AgNO₃, InCl₃, FeCl₃, Ti(OR)₄, TiCl₄, TiCl₃, CoCl₃, NiCl₂, SiCl₄, GeCl₄, GaH₃, ZnEt₂, Al(OR)₃, Zr(OR)₄ and Si(OR)₄,
wherein with Me is an alkali metal, and R is selected from the group consistin of an unbranched C₁-C₈ alkyl radical, a branched C₁-C₈ alkyl radical, ferrocene, Zeise's salt, and SnBu₃H.

26. The article according to claim 24, wherein the metal cluster comprises one or more clusters of gold, platinum or palladium.

27. The article according to claim 24, wherein the metal oxide cluster comprises one or more clusters of titanium dioxide, iron oxide or cobalt oxide.

28. The article according to claim 24, wherein at least some of the polymer units are loaded with a cluster of mixed metallic systems.

29. The article according to claim 28, wherein the cluster of mixed metallic systems comprises at least one mixed metallic system selected from the group consisting of Au/Fe₂O₃, Au/CoO, Au/Co₃O₄, Au/ZnO, Au/TiO₂, Au/ZrO₂, Au/Al₂O₃, Au/In₂O₃, Pd/Al₂O₃, Pd/ZrO₂, Pt/graphite and Pt/Al₂O₃.

30. An article, comprising:
an optical element having a surface; and
an antireflection surface structure,
wherein the antireflection surface structure comprises metal clusters and/or metal oxide clusters, which are distributed in an essentially regular arrangement on the surface of the optical element.

31. The article according to claim 30, wherein the metal cluster comprises one or more clusters of gold, platinum or palladium.

32. The article according to claim 30, wherein the metal oxide cluster comprises one or more clusters of titanium dioxide, iron oxide.

33. The article according to claim 30, wherein the antireflection surface structure comprises one or more clusters of mixed metallic systems.

34. The article according to claim 33, wherein the cluster of mixed metallic systems comprises at least one mixed metallic system selected from the group consisting of Au/Fe₂O₃, Au/CoO, Au/Co₃O₄, Au/ZnO, Au/TiO₂, Au/ZrO₂, Au/Al₂O₃, Au/In₂O₃, Pd/Al₂O₃, Pd/ZrO₂, Pt/graphite and Pt/Al₂O₃.
